(19) United States
(12) Patent Application Publication
(10) Pub. No.: US 2014/0244277 A1
(43) Pub. Date: Aug. 28, 2014

(54) SYSTEM AND METHOD FOR REAL-TIME MONITORING AND MANAGEMENT OF PATIENTS FROM A REMOTE LOCATION

(71) Applicant: COGNIZANT TECHNOLOGY SOLUTIONS INDIA PVT. LTD., Chennai (IN)

(72) Inventors: Geelapaturu Subrahmanya Venkata Radha Krishna Rao, Chennai (IN); Karthik Sundararaman, Chennai (IN); Vedamanickam Arun Muthuraj, Tirupur District (IN)

(73) Assignee: Cognizant Technology Solutions India Pvt. Ltd., Chennai (IN)

(21) Appl. No.: 13/862,980

(22) Filed: Apr. 15, 2013

(30) Foreign Application Priority Data
Feb. 25, 2013 (IN) 818/CHE/2013

(51) Int. Cl. G06F 19/00

(52) U.S. Cl. CPC G06F 19/34
USPC 705/2

(57) ABSTRACT

A system and computer-implemented method for real-time monitoring and management of patients from a remote location is provided. The system comprises one or more patient's communication devices configured to facilitate users to enter patient related data via a healthcare application. The system further comprises an analyzing and processing module, residing in a cloud based environment, configured to receive and process the patient related data. The analyzing and processing module is further configured to send alerts to physicians based on at least one of: the received and the processed patient related data. Furthermore, the analyzing and processing module is configured to facilitate the physicians to access the received and the processed patient related data and provide responses via the healthcare application. Also, the analyzing and processing module is configured to send alerts to the users and facilitate the users to access the responses.

### CROSS-REFERENCE TO RELATED APPLICATIONS

The present application claims priority from Indian Patent Application No. 818/CHE/2013 filed Feb. 25, 2013, the disclosure of which is hereby incorporated herein by reference.

### FIELD OF THE INVENTION

The present invention relates generally to health management. More particularly, the present invention provides a system and method for real-time monitoring and management of patients from a remote location.

### BACKGROUND OF THE INVENTION

Globally, health service providers aspire to provide affordable and quality healthcare services to people. To meet the healthcare needs of the people, hospitals and healthcare organizations exist that provide healthcare services to people living in urban as well as rural areas. Numerous organizations including governmental, non-governmental, private and corporate have also initiated various healthcare schemes to provide healthcare services to people especially in rural areas.

However, the quality of healthcare services in the rural and urban areas is not evenly distributed. Also, providing quality healthcare services to rural and remote areas is challenging and expensive due to lack of adequate logistics support, remote locations, power problems and lack of healthcare professionals. Furthermore, people in the rural and remote locations find it difficult to travel long distances to seek healthcare services due to time and financial constraints. In addition, it is often difficult to get patients suffering from neurological disorders, mobility disorders, cardiovascular disorders and other diseases to visit the hospitals and healthcare organizations. Moreover, people generally prefer to go to the hospitals only during emergencies and not for regular checkups, rehabilitation and post-operative checkups.

To overcome the abovementioned problems, mobile healthcare services such as healthcare vans, ambulances, mobile medical units, mobile clinics and field hospitals exist for catering to healthcare needs of people by reaching them instead of the other way around. However, the mobile healthcare services are unable to meet all the requirements of the people and cannot cater to specialized healthcare needs of the people.

To overcome the abovementioned problems, telemedicine systems and methods exists which facilitate in providing remote healthcare services. However, the abovementioned problems are not alleviated by the existing telemedicine systems and methods. Furthermore, the existing telemedicine systems are based on a client-server architecture which is costly and difficult to implement. Also, the existing telemedicine systems and methods are unable to provide effective therapeutic and diagnostic support to the patients.

In light of the above mentioned disadvantages, there is a need for a system and method for real-time monitoring and management of patients from a remote location. Further, there is a need for an effective, inexpensive and reliable healthcare solution requiring minimal infrastructure, investments and maintenance for providing healthcare services. Furthermore, there is a need for providing efficient diagnostic, therapeutic, and specialized services to patients living in remote and rural as well as urban areas. Also, there is a need for a system and method which is simple and easy to use for the patients and can be integrated with existing communication devices such as mobile phones, Personal Digital Assistants (PDAs), desktops and laptops. In addition, there is a need for a system and method that is scalable to meet future healthcare demands.

### BRIEF SUMMARY OF THE INVENTION

A system and computer-implemented method for real-time monitoring and management of patients from a remote location is provided. The system comprises one or more patient's communication devices configured to facilitate one or more users to enter patient related data via a healthcare application. The system further comprises an analyzing and processing module, residing in a cloud based environment, configured to receive and process the patient related data. The analyzing and processing module is further configured to send one or more alerts to one or more physicians based on at least one of: the received and the processed patient related data. Furthermore, the analyzing and processing module is configured to facilitate the one or more physicians to access the received and the processed patient related data and provide one or more responses via the healthcare application using one or more physician's communication devices. Also, the analyzing and processing module is configured to send one or more alerts to the one or more users and facilitate the one or more users to access the one or more responses via the healthcare application.

In an embodiment of the present invention, the healthcare application is configured to provide an interface to the one or more users and the one or more physicians to communicate with the analyzing and processing module residing in the cloud based environment. In an embodiment of the present invention, the analyzing and processing module comprises a messaging module configured to send the one or more alerts to the one or more physicians and the one or more users.

In an embodiment of the present invention, the analyzing and processing module comprises a patient data recording module configured to receive the patient related data, wherein the received patient related data includes at least one of: one or more audio signals corresponding to speech recordings of one or more patients, one or more videos of the one or more patients and values of one or more patient parameters. In an embodiment of the present invention, the one or more videos of the one or more patients comprise recordings of movement of one or more body parts of the one or more patients. In an embodiment of the present invention, the one or more patient parameters include at least one of: ECG records, Blood Pressure (BP) level, temperature, blood cells count, pulse rate and sugar level.

In an embodiment of the present invention, the analyzing and processing module further comprises an audio processing module configured to process the one or more audio signals received from the patient data recording module. Also, the analyzing and processing module comprises a video processing module configured to process the one or more videos received from the patient data recording module. Furthermore, the analyzing and processing module comprises a data analyzer configured to process and analyze the one or more patient parameters. In addition, the analyzing and processing module comprises a patient repository configured to store at least one of: the received and the processed patient related data. The analyzing and processing module further comprises a response module configured to facilitate the one or more physicians to access the received and the processed patient related data and further configured to facilitate updating one or more responses received from the one or more physicians in the patient repository.

In an embodiment of the present invention, the audio processing module comprises a notch filter configured to process the one or more received audio signals to remove noise. The audio processing module further comprises an audio segmentation module configured to divide the one or more processed audio signals into one or more segments. Furthermore, the audio processing module comprises a hamming window function module configured to process each of the one or more segments to remove spectral leakage using smoothing windows. Also, the audio processing module comprises a frequency detector configured to detect fundamental frequency of each of the one or more processed segments. In addition, the audio processing module comprises an extractor and analyzer module configured to calculate at least one of: average fundamental frequency, minimum fundamental frequency, maximum fundamental frequency, one or more jitter parameters and one or more shimmer parameters using the detected fundamental frequency of each of the one or more processed segments. In an embodiment of the present invention, the video processing module comprises a frames extractor configured to extract one or more frames from the one or more received videos. The video processing module further comprises an object detector configured to identify face and eye region in the one or more extracted frames. Furthermore, the video processing module comprises an integro-differential operator configured to locate an iris within the eye region and further configured to calculate coordinates of centroid of the iris. Also, the video processing module comprises a graph generator and analyzer configured to generate a graph illustrating the movement of the iris using the calculated coordinates of the centroid of the iris. In an embodiment of the present invention, the data analyzer processes and analyzes the one or more patient parameters by comparing the values of the one or more patient parameters with predetermined values.

The computer-implemented method for real-time monitoring and management of patients from a remote location, via program instructions stored in a memory and executed by a processor, comprises facilitating one or more users to enter patient related data via a healthcare application. The computer-implemented method further comprises receiving and processing the patient related data. Furthermore, the computer-implemented method comprises sending one or more alerts to one or more physicians based on at least one of: the received and the processed patient related data. Also, the computer-implemented method comprises facilitating the one or more physicians to access the received and the processed patient related data and provide one or more responses via the healthcare application. In addition, the computer-implemented method comprises sending one or more alerts to the one or more users and facilitating the one or more users to access the one or more responses via the healthcare application.

In an embodiment of the present invention, the step of receiving and processing the patient related data is performed in a cloud based environment. In an embodiment of the present invention, the step of processing the received patient related data comprises processing one or more audio signals corresponding to speech recordings of one or more patients to remove noise. The step of processing the received patient related data further comprises dividing the one or more processed audio signals into one or more segments. Furthermore, the step of processing the received patient related data comprises processing each of the one or more segments to remove spectral leakage using smoothing windows. Also, the step of processing the received patient related data comprises detecting fundamental frequency of each of the one or more processed segments. In addition, the step of processing the received patient related data comprises calculating at least one of: average fundamental frequency, minimum fundamental frequency, maximum fundamental frequency, one or more jitter parameters and one or more shimmer parameters using the detected fundamental frequency of each of the one or more processed segments.

In an embodiment of the present invention, the step of processing the patient related data comprises extracting one or more frames from one or more videos of one or more patients. The step of processing the patient related data further comprises identifying face and eye region in the one or more extracted frames. Furthermore, the step of processing the patient related data comprises locating an iris within the eye region. Also, the step of processing the patient related data comprises calculating coordinates of centroid of the iris. In addition, the step of processing the patient related data comprises generating a graph illustrating movement of the iris using the calculated coordinates of the centroid of the iris. In an embodiment of the present invention, the one or more videos of the one or more patients comprise recordings of movement of one or more body parts of the one or more patients. In an embodiment of the present invention, the step of processing the patient related data includes comparing the values of one or more patient parameters with predetermined values.

A computer program product for real-time monitoring and management of patients from a remote location comprising: a non-transitory computer-readable medium having computer-readable program code stored thereon, the computer-readable program code comprising instructions that when executed by a processor, cause the processor to facilitate one or more users to enter patient related data via a healthcare application. The processor further receives and processes the patient related data. Furthermore, the processor sends one or more alerts to one or more physicians based on at least one of: the received and the processed patient related data. Also, the processor facilitates the one or more physicians to access the received and the processed patient related data and provide one or more responses via the healthcare application. In addition, the processor sends one or more alerts to the one or more users and facilitates the one or more users to access the one or more responses via the healthcare application.

In an embodiment of the present invention, receiving and processing the patient related data is performed in a cloud based environment. In an embodiment of the present invention, processing the received patient related data comprises processing one or more audio signals corresponding to speech recordings of one or more patients to remove noise. Further, processing the received patient related data comprises dividing the one or more processed audio signals into one or more segments. Furthermore, processing the received patient related data comprises processing each of the one or more segments to remove spectral leakage using smoothing windows. Also, processing the received patient related data comprises detecting fundamental frequency of each of the one or more processed segments. In addition, processing the received patient related data comprises calculating at least one of: average fundamental frequency, minimum fundamental frequency, maximum fundamental frequency, one or more jitter parameters and one or more shimmer parameters using the detected fundamental frequency of each of the one or more processed segments.

In an embodiment of the present invention, processing the patient related data comprises: extracting one or more frames from one or more videos of one or more patients. Further, processing the patient related data comprises identifying face and eye region in the one or more extracted frames. Furthermore, processing the patient related data comprises locating an iris within the eye region. Also, processing the patient related data comprises calculating coordinates of centroid of the iris. In addition, processing the patient related data comprises generating a graph illustrating movement of the iris using the calculated coordinates of the centroid of the iris. In an embodiment of the present invention, the one or more videos of the one or more patients comprise recordings of movement of one or more body parts of the one or more patients. In an embodiment of the present invention, processing the patient related data includes comparing the values of one or more patient parameters with predetermined values.

### BRIEF DESCRIPTION OF THE DRAWINGS

The present invention is described by way of embodiments illustrated in the accompanying drawings wherein:

FIG. 1 is a block diagram illustrating a system for real-time monitoring and management of patients from a remote location, in accordance with an embodiment of the present invention;

FIG. 2 is a detailed block diagram illustrating an analyzing and processing module for real-time monitoring and management of patients from a remote location, in accordance with an embodiment of the present invention;

FIG. 3 is a detailed block diagram illustrating a healthcare application, in accordance with an embodiment of the present invention;

FIG. 4 is a detailed block diagram illustrating an audio processing module, in accordance with an embodiment of the present invention;

FIG. 5 is a detailed block diagram illustrating a video processing module, in accordance with an embodiment of the present invention;

FIGS. 6A and 6B represent a flowchart illustrating a method for real-time monitoring and management of patients from a remote location, in accordance with an embodiment of the present invention;

FIG. 7 is a flowchart illustrating a method for processing one or more audio signals, in accordance with an embodiment of the present invention;

FIG. 8 is a flowchart illustrating a method for processing one or more videos, in accordance with an embodiment of the present invention; and

FIG. 9 illustrates an exemplary computer system in which various embodiments of the present invention may be implemented.

### DETAILED DESCRIPTION

A system and method for real-time monitoring and management of patients from a remote location is described herein. The invention provides for an effective, inexpensive and reliable healthcare solution requiring minimal infrastructure, minimal investments and low maintenance for providing healthcare services to the patients. The invention further provides efficient and real-time diagnostic, therapeutic and specialized services to the patients living in rural and remote areas as well as urban areas. Furthermore, the invention provides a system and method which is simple and easy to use for the patients and can be integrated with existing communication devices. In addition, the invention provides a system and method that is scalable to meet future healthcare demands.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

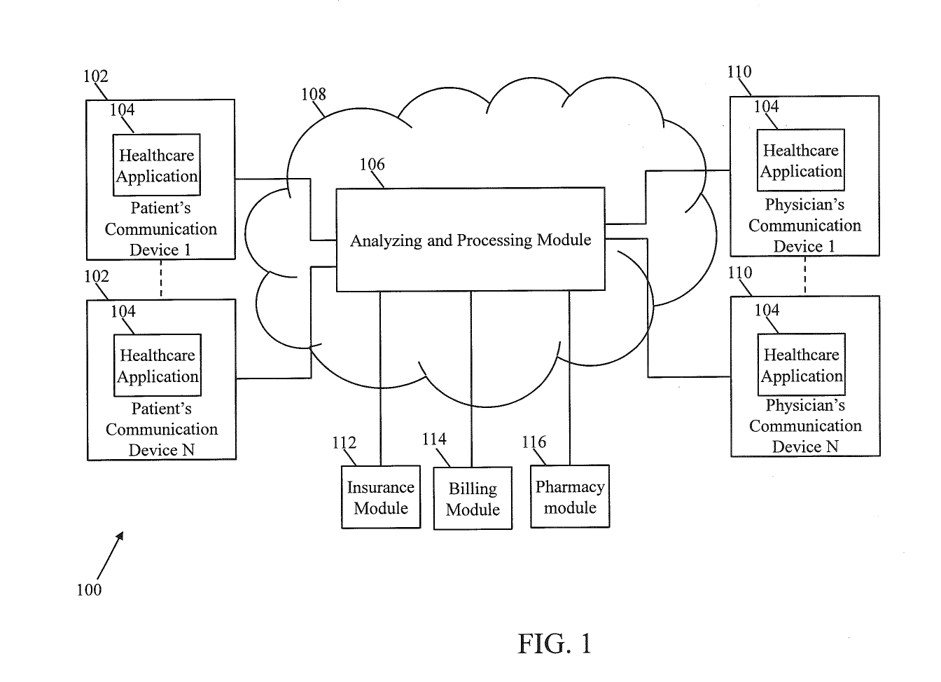

FIG. 1 is a block diagram illustrating a system 100 for real-time monitoring and management of patients from a remote location, in accordance with an embodiment of the present invention. The system 100 comprises one or more patient's communication devices 102, an analyzing and processing module 106 residing in a cloud based environment 108 and one or more physician's communication devices 110. The one or more patient's communication devices 102 and the one or more physician's communication devices 110 comprise a healthcare application 104 to provide an interface to one or more users and one or more physicians to communicate with the system 100.

The one or more patient's communication devices 102 are configured to facilitate the one or more users to enter patient related data. In an embodiment of the present invention, the one or more patient's communication devices include, but not limited to, a desktop, a notebook, a laptop, a mobile phone, a smart phone and a Personal Digital Assistant (PDA). In an embodiment of the present invention, the one or more users include, but not limited to, patients, a Community Health Workers (CHW) and healthcare personnel. The CHWs assist one or more patients in entering the patient related data via the one or more patient's communication devices 102. In an embodiment of the present invention, the patient related data includes, but not limited to, patient's personal details such as age, medical history, health complaints, symptoms and duration of symptoms, one or more patient parameters, audio/speech recordings of the one or more patients, video recordings of the one or more patients, wound images, postal address, payment details such as bank account number or credit card details. In an embodiment of the present invention, the one or more patient parameters include, but not limited to, Blood Pressure (BP) level, sugar level, temperature, pulse rate, blood cells count, ECG (Electro CardioGram) records and any other health parameters.

The healthcare application 104 provides an interface to the one or more users to enter the patient related data. In an embodiment of the present invention, the healthcare application 104 renders a health complaint form on the one or more patient's communication devices 102. The health complaint form has text boxes corresponding to patient's personal details, primary health complaint, additional complaints, symptoms and their duration, sugar level, BP level, insurance details, payment details and other patient parameters and the patient related data. In addition, the health complaint form provides options to upload images of ECG records, wounds, injuries and any other images and health related documents. Further, the healthcare application 104 provides options for live audio and video streaming to facilitate real-time communication between the one or more patients and the one or more physicians. In an embodiment of the present invention, the one or more patients can also undergo speech tests and video tests by selecting a corresponding option provided by the healthcare application 104. The speech tests and the video tests are diagnostic tests that the one or more patients undergo which facilitate the one or more physicians in identifying diseases including, but not limited to, Progressive Supranuclear Palsy (PSP), Parkinson's, epilepsy, stroke, multiple sclerosis, Alzheimer's, other neurological disorders, speech disorders and other diseases.

The analyzing and processing module 106 is configured to receive and store the entered patient related data from the one or more patient's communication devices 102 via the healthcare application 104. The analyzing and processing module 106 comprises one or more repositories including, but not limited to, a patient repository to store the received data. In an embodiment of the present invention, the analyzing and processing module 106 resides in the cloud based environment 108. The cloud based environment 108 refers to a collection of resources that are delivered as a service via the healthcare application 104 over a network such as internet. The resources include, but not limited to, hardware and software for providing services such as, data storage services, computing services, processing services and any other information technological services. In an embodiment of the present invention, the healthcare application 104 acts as a middleware to facilitate communication with the analyzing and processing module 106 in the cloud based environment 108 via internet. In an embodiment of the present invention, the system 100 is deployed as Software as a Service (SaaS) model in the cloud based environment 108 which can be accessed via the healthcare application 104 using a web browser.

In an embodiment of the present invention, the cloud based environment 108 provides computing instances which can be increased based on load to accommodate growing number of users and corresponding data thereby making the system 100 scalable. Further, the cloud based environment 108 requires less maintenance and can be accessed from anywhere resulting in high availability. In an embodiment of the present invention, the cloud based environment 108 hosts the analyzing and processing module 106 comprising servlets and one or more repositories. In an embodiment of the present invention, once the one or more users submit the patient related data via the healthcare application 104, the patient related data is received by the servlets. The servlets are programmed to facilitate updating and storing the received patient related data into one or more repositories hosted on the cloud based environment 108. The cloud based environment 108 also hosts stored procedures which facilitate sending alerts and messages to physicians, pharmacists and patients once data is updated in the one or more repositories hosted on the cloud based environment 108.

The analyzing and processing module 106 is also configured to process the received patient related data including, but not limited to, the one or more images, one or more audio signals corresponding to the speech recordings of the one or more patients and the one or more video recordings of the one or more patients to assist the one or more physicians in efficiently diagnosing the health condition of the one or more patients. In an embodiment of the present invention, the processed patient related data is stored in the patient repository.

The analyzing and processing module 106 also comprises repositories having pre-stored data corresponding to the one or more physicians. The pre-stored data corresponding to the one or more physicians include, but not limited to, physician details such as specialization, employment details, contact address, contact numbers and email address. The pre-stored data corresponding to the one or more physicians is used by the analyzing and processing module 106 to send one or more alerts to the one or more physicians based on the received patient related data and the processed patient related data. In an embodiment of the present invention, the analyzing and processing module 106 invokes one or more Application Programming Interfaces (APIs) that facilitate sending the one or more alerts via appropriate communication channels including, but not limited to, Short Messaging Service (SMS), electronic mail and facsimile. In an embodiment of the present invention, the analyzing and processing module 106 comprises one or more servlets to facilitate communication between various modules of the system 100.

The one or more physician's communication devices 110 are configured to facilitate the one or more physicians to access the stored patient related data and the processed patient related data. The one or more physician's devices 110 also comprise the healthcare application 104 which provides an interface to the one or more physicians to access the patient related data. In an embodiment of the present invention, the one or more physician's communication devices 110 include, but not limited to, a desktop, a notebook, a laptop, a mobile phone, a smart phone and a Personal Digital Assistant (PDA).

In an embodiment of the present invention, once the one or more physicians receive the one or more alerts from the analyzing and processing module 106, the one or more physicians access the healthcare application 104 on the one or more physician's communication devices 110. The healthcare application 104 comprises a search box to facilitate the one or more physicians to access the patient related data. In an embodiment of the present invention, the one or more physicians receive a patient identification code as an alert. The patient identification code is a unique combination of at least one of characters, alphabets and numbers such as, but not limited to, alphanumeric code, patient name, patient's date of birth and a combination of the patient's personal details which is generated by the analyzing and processing module 106 corresponding to a particular patient. The one or more physicians enter the received patient identification code in the search box to access the patient related data. The one or more physicians then diagnose the health condition and prescribe treatment and medication based on the accessed data including, but not limited to, the received and stored patient related data and the processed patient related data via the healthcare application 104.

The analyzing and processing module 106 then receives one or more responses from the one or more physicians via the healthcare application 104 on the one or more physician's communication devices 110. The one or more responses comprise information including, but not limited to, diagnosis, treatment and medical prescription. Once the analyzing and processing module 106 receives the one or more responses, the analyzing and processing module 106 invokes the one or more APIs to facilitate sending the one or more alerts via the various communication channels to the one or more users. The one or more users can then access the one or more responses via the healthcare application 104 residing in the one or more patient's communication devices 102. In an embodiment of the present invention, the one or more users enter the patient identification code in a search box provided by the healthcare application 104 which retrieves the one or more responses from the analyzing and processing module 106 and renders it on the one or more patient's communication devices 102.

The analyzing and processing module 106 also communicates with external systems including, but not limited to, an insurance module 112, a billing module 114 and a pharmacy module 116.

The insurance module 112 facilitates communication with the external one or more insurance carriers systems to fetch insurance details and facilitate payment processing.

The billing module 114 facilitates billing and payment processing. In an embodiment of the present invention, the patient related data includes, but not limited to, credit card details and bank account details which helps in settling the bills and processing the payments via the billing module 114.

The pharmacy module 116 facilitates communication with one or more pharmacies for delivering medicines prescribed by the one or more physicians. In an embodiment of the present invention, once the analyzing and processing module 106 receives the one or more responses from the one or more physicians, the analyzing and processing module 106 sends the medical prescription and patient address to the one or more pharmacies via the pharmacy module 116.

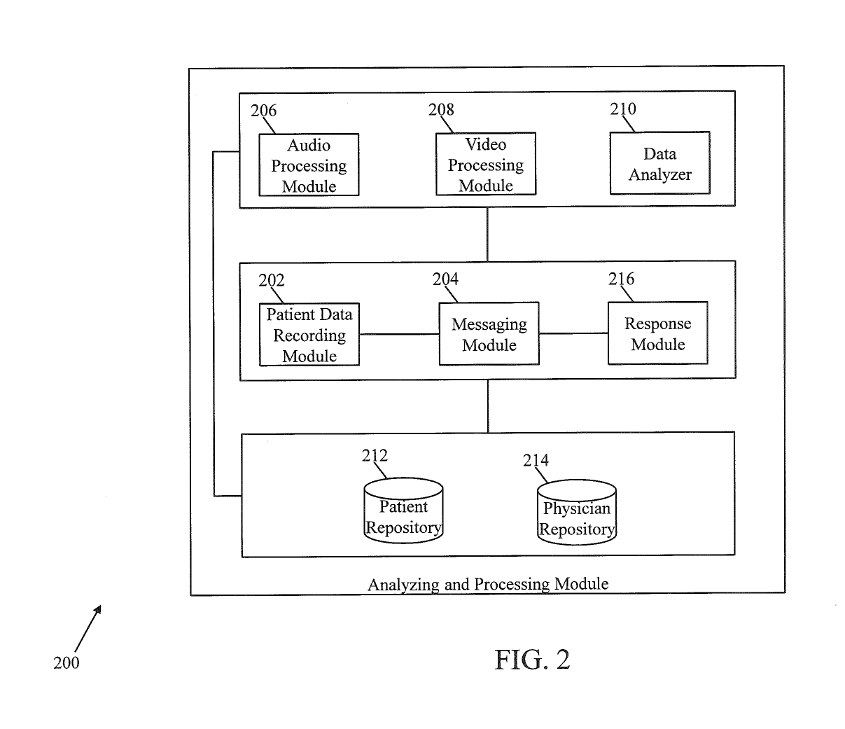

FIG. 2 is a detailed block diagram illustrating an analyzing and processing module 200 for real-time monitoring and management of patients from a remote location, in accordance with an embodiment of the present invention. The analyzing and processing module 200 comprises a patient data recording module 202, a messaging module 204, an audio processing module 206, a video processing module 208, a data analyzer 210, a patient repository 212, a physician repository 214 and a response module 216.

The patient data recording module 202 receives the patient related data from the one or more patient's communication devices 102 (FIG. 1). The patient data recording module 202 then facilitates storing the received patient related data in the patient repository 212. In an embodiment of the present invention, once the one or more users enter the patient related data in the health complaint form and select the submit option, the patient data recording module 202 starts receiving and consequently storing the received data into the patient repository 212 for further processing and use.

In an embodiment of the present invention, the patient data recording module 202 comprise servlets which facilitate connection with the patient repository 212 when the health complaint form is submitted. Once, the health complaint form is submitted and stored, the control is transferred to the messaging module 204.

The messaging module 204 is configured to send the one or more alerts to the one or more physicians once the patient data recording module 202 receives the patient related data. In operation, the messaging module 204 extracts the pre-stored contact details of the one or more physicians from the physician repository 214 using the patient related data which also includes, but not limited to, consulting physician's name. The consulting physician's name facilitates the messaging module 214 in extracting the contact details of the consulting physician from the physician repository 214. In an embodiment of the present invention, the messaging module 204 comprises servlets that facilitate sending the one or more alerts to the one or more physicians. In an embodiment of the present invention, the messaging module 204 invokes the one or more APIs that facilitate sending the one or more alerts via the various communication channels.

The audio processing module 206 is configured to receive and process the patient related data such as, but not limited to, the one or more audio signals from the patient data recording module 202. The one or more audio signals are audio/speech recordings of the one or more patients that facilitate the one or more physicians in diagnosing various disorders such as, but not limited to, neurological disorders and speech disorders. In an embodiment of the present invention, the audio processing module 206 calculates various audio parameters such as, but not limited to, fundamental frequency, one or more jitter parameters and one or more shimmer parameters corresponding to the one or more audio signals which are referred to by the one or more physicians for diagnosing the various disorders.

The video processing module 208 is configured to process the one or more patient parameters such as, but not limited to, the one or more videos received from the patient data recording module 202. In an embodiment of the present invention, the one or more patients undergo the video tests and record the one or more videos. The one or more videos of the one or more patients comprise recordings of movement of one or more body parts of the one or more patients. The one or more videos are then processed by the video processing module 208 to extract relevant and meaningful data such as, but not limited to, graphs illustrating movement of the eyes and the iris which facilitate the one or more physicians in diagnosis and prescribing appropriate treatment.

The data analyzer 210 is configured to process and analyze the patient related data such as values of the one or more patient parameters including, but not limited to, ECG records, BP level, blood sugar level, pulse rate and White Blood Cells (WBCs) count and Red Blood Cells (RBCs) count. The data analyzer 201 comprises one or more algorithms that compare the values of the one or more patient parameters with predetermined values to determine if the one or more patient parameters are within the normal range. In an exemplary embodiment of the present invention, the data analyzer 210 comprises one or more algorithms to analyze the ECG records of the one or more patients by comparing with predetermined threshold values. If the ECG records match with the predetermined threshold values then the ECG is considered to be normal, else the aberrations and abnormalities in the ECG are determined. The aberrations and abnormalities in the ECG facilitate the data analyzer 210 to determine the CardioVascular Disease (CVD) corresponding to the determined aberration and abnormality. In another exemplary embodiment of the present invention, the data analyzer 210 comprises one or more algorithms to analyze the sugar level of the patient by comparing with predetermined minimum and maximum threshold values to determine if the patient's sugar level is within the normal range.

The patient repository 212 is configured to store including, but not limited to, the patient related data and the processed patient related data. In an embodiment of the present invention, the processed patient related data include, but not limited to, one or more audio parameters calculated by the audio processing module 206, graphs illustrating movement of the eyes and the iris generated by the video processing module 208 and data generated by the data analyzer 210 after processing and analyzing the patient related data.

The physician repository 214 contains pre-stored data corresponding to the one or more physicians including, but not limited to, physician details such as age, specialization, employment details, contact address, contact numbers and email address.

The response module 216 is configured to facilitate the one or more physicians to access the stored patient related data and the processed patient related data after receiving the one or more alerts. The one or more physicians access the stored patient related data and the processed patient related data via the healthcare application 104 (FIG. 1) residing in the one or more physician's communication devices 110 (FIG. 1). In an embodiment of the present invention, the response module 216 renders a response form on the one or more physician's devices 110 via the healthcare application 104 (FIG. 1). The one or more physicians enter the patient identification code received as one or more alerts in a search box in the response form to access the data corresponding to the patient. The one or more physicians then diagnose the health condition, prescribe treatment and medicines based on the accessed data corresponding to the patient including, but not limited to, the patient related data and the processed patient related data. The response module 216 is further configured to facilitate updating the one or more responses including information such as, but not limited to, diagnosis, treatment and medical prescription received from the one or more physicians in the patient repository 212. In an embodiment of the present invention, the response module 216 comprises servlets which facilitate updating the patient repository 212 with the one or more responses.

Once the one or more responses are received, the messaging module 204 alerts the one or more users of the received one or more responses via the one or more communication channels. The one or more users can then access the one or more responses stored in the patient repository 212 via the healthcare application 104 (FIG. 1) residing in the one or more patient's communication devices 102 (FIG. 1).

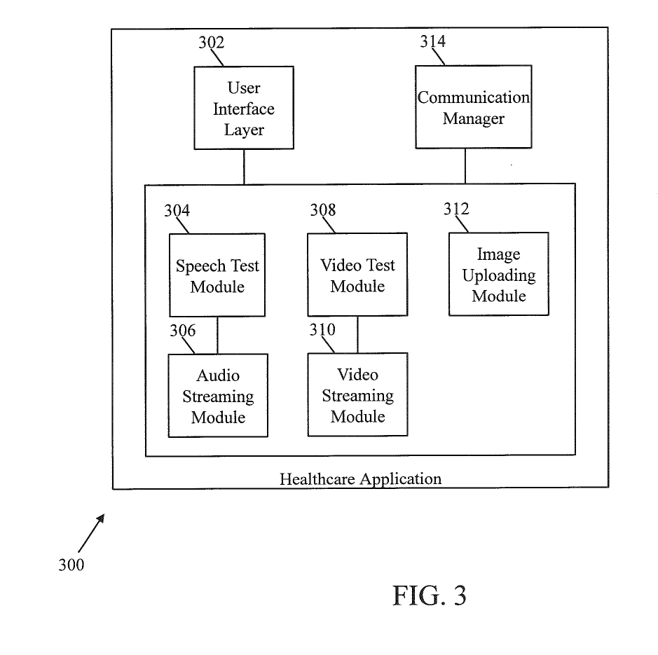

FIG. 3 is a detailed block diagram illustrating a healthcare application 300, in accordance with an embodiment of the present invention. The healthcare application 300 comprises a user interface 302, a speech test module 304, an audio streaming module 306, a video test module 308, a video streaming module 310, an image uploading module 312 and a communication manager 314.

The user interface 302 is a front-end interface to facilitate the one or more users and the one or more physicians to access the system 100 (FIG. 1). The user interface 302 provides options to perform tasks such as, but not limited to, authenticating the one or more users and the one or more physicians, entering the patient related data, uploading images, streaming live audio and video and accessing the entered data corresponding to the one or more patients. In an embodiment of the present invention, the user interface 302 includes, but not limited to, a graphical user interface, a character user interface, a web based interface and a touch screen interface.

In an embodiment of the present invention, the user interface 302 provides options to facilitate the one or more users to fill the health complaint form. In another embodiment of the present invention, the one or more users undergo one or more speech tests and record the one or more audio signals by selecting an appropriate option provided by the user interface 302. In yet another embodiment of the present invention, the user interface 302 provides options to the one or more physicians to access the data corresponding to the one or more patients and prescribe treatment and medicines.

The speech test module 304 is configured to check various disorders that affect vocal cords of the patients using the one or more speech tests. The one or more speech tests are diagnostic tests that are prescribed by the one or more physicians for diagnosing disorders such as, but not limited to, neurological disorders and speech disorders by recording sound/speech produced by the one or more patients. The one or more speech tests are pre-stored in the speech test module 304 and rendered onto the user interface 302. Further, the one or more users select the one or more speech tests that the one or more patients has to take via the user interface 302 to facilitate recording the speech and generating corresponding one or more audio signals that are transmitted via the audio streaming module 306 to facilitate diagnosis.

In an exemplary embodiment of the present invention, the one or more patients undergo sustained phonation test in which the patients are required to make continuous, constant and long sound at a comfortable pitch and loudness. The sustained phonation test is used to characterize dysphonia which helps the one or more physicians in diagnosing neurological disorders such as, but not limited to, Parkinson's disease. The dysphonia may occur in people suffering from Parkinson's disease due to impairment in the ability of the vocal organs to produce voice sounds, breakdown of stable periodicity in voice production and increased breathiness. Further, the dysphonia is assessed by the one or more physicians by listening to the one or more audio recordings and analyzing vowels sounded at a constant pitch and loudness. In another exemplary embodiment of the present invention, the one or more patients undergo DiaDochoKinetic (DDK) test which is a speech test for assessing the DDK rate. The DDK rate measures how quickly the patient can accurately produce a series of rapid and alternating sounds. The DDK test requires rapid, steady, constant and long syllable repetition. The DDK test assist the one or more physicians in assessing a patient's ability to produce a series of rapid and alternating sounds using different parts of the mouth and assessing oral motor skills of the patient which requires neuromuscular control. In yet another exemplary embodiment of the present invention, the one or more patients may undergo a speech test which requires continuous speech for approximately 80 seconds which helps the one or more physicians in diagnosing Parkinson's disease. The patients suffering from Parkinson's disease have a characteristic monotone lacking melody, decreased standard deviation of fundamental frequency, slurred and unclear speech due to lack of coordination of facial muscles and reduced word rate.

The audio streaming module 306 is configured to connect with microphone of the one or more patient's communication devices 102 (FIG. 1) and transmit the one or more audio signals corresponding to the one or more speech tests. The microphone is an acoustic to electric transducer that converts sounds generated by the one or more patients into electric signals (also referred to as the one or more audio signals). Further, the one or more audio signals are transmitted by the audio streaming module 306 to the analyzing and processing module 106 (FIG. 1) via the communication manager 314. In an embodiment of the present invention, the audio streaming module 306 facilitates real-time and continuous streaming of the one or more audio signals to facilitate live audio communication with the one or more physicians.

The video test module 308 is configured to check various disorders that affect movement of the eyes of the patients using the one or more video tests. The one or more video tests are visual diagnostic tests that are prescribed by the one or more physicians and are pre-stored in the video test module 308. Further, the one or more patients select the one or more video tests via the user interface 302 to record corresponding one or more videos that are transmitted via the video streaming module 310 to facilitate the one or more physicians in proper diagnosis. In an embodiment of the present invention, prior to the one or more video tests, camera of the one or more patient's communication devices 102 (FIG. 1) is calibrated and the camera settings are accordingly arranged using camera calibration techniques including, but not limited to, standard calibration checkerboard method.

In an exemplary embodiment of the present invention, the one or more patients undergo the one or more video tests such as, but not limited to, viewing a visual target moving horizontally and vertically on a display screen of a patient's device 102 (FIG. 1). While the one or more patients view the visual target, the camera records the movement of the eyes in the form of the one or more videos. The one or more videos can have various video file formats including, but not limited to, Audio Video Interleave (AVI) format, Moving Pictures Experts Group (MPEG) format, quicktime format, RealMedia (RM) format and Windows Media Video (WMV) format. Once the one or more videos are recorded, the control is transferred to the video streaming module 310 for transmitting the one or more videos to the analyzing and processing module 106 (FIG. 1) for further processing via the communication manager 314.

The image uploading module 312 is configured to facilitate uploading the one or more images via the user interface 302. In an embodiment of the present invention, the one or more images include, but not limited to, ECG records, wound pictures and any other images useful for diagnosis. In an embodiment of the present invention, the image uploading module 312 transmits the uploaded one or more images to the analyzing and processing module 106 (FIG. 1) via the communication manager 314.

The communication manager 314 is configured to facilitate communication with the analyzing and processing module 106 (FIG. 1) residing in the cloud based environment 108 (FIG. 1). In an embodiment of the present invention, the communication manager 314 facilitates interaction with the analyzing and processing module 106 (FIG. 1) via a web browser. In another embodiment of the present invention, the communication manager facilitates communication with the analyzing and processing module 106 (FIG. 1) via one or more virtual sessions.

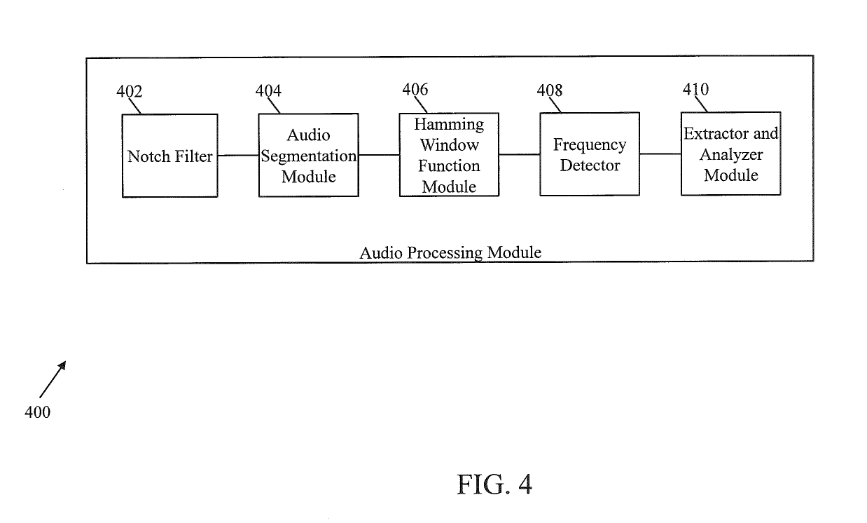

FIG. 4 is a detailed block diagram illustrating an audio processing module 400, in accordance with an embodiment of the present invention. The audio processing module 400 comprises a notch filter 402, an audio segmentation module 404, a hamming window function module 406, a frequency detector 408 and an extractor and analyzer module 410.

The notch filter 402 is configured to receive the one or more audio signals from the one or more patient's communication devices 102 (FIG. 1) via the patient data recording module 202 (FIG. 2). The notch filter 402 is further configured to process the one or more audio signals by removing noise. In an embodiment of the present invention, the notch filter 402 is centered at a frequency of 50 Hz to remove background noise. Once the one or more audio signals are processed, the one or more processed audio signals are sent to the audio segmentation module 404.

The audio segmentation module 404 is configured to divide the one or more processed audio signals into one or more segments using one or more audio segmentation algorithms. In an embodiment of the present invention, the one or more processed audio signals are divided into one or more segments of 20 milliseconds duration with an overlap of 75% using the one or more audio segmentation algorithms.

The hamming window function module 406 is configured to process each of the one or more segments using one or more smoothing windows to remove spectral leakage. In an embodiment of the present invention, the spectral leakage is removed by using a smoothing window such as, but not limited to, hamming window to remove edge effects that result in spectral leakage in Fast Fourier Transform (FFT) of the one or more segments. The FFT of the one or more segments facilitates in providing a graphical representation of frequency vs. amplitude of the one or more audio signals. Once the one or more segments are processed, the control is transferred to the frequency detector 408.

The frequency detector 408 is configured to detect fundamental frequency of each of the one or more processed segments. In an embodiment of the present invention, the frequency detector 408 comprises a Harmonic Product Spectrum (HPS) algorithm for detecting the fundamental frequency. Further, the HPS algorithm compresses the spectrum of each of the one or more processed segments by downsampling the spectrum and comparing with original spectrum to determine one or more harmonic peaks. The original spectrum is first compressed by a factor of two and then compressed by a factor of three. The three spectra are then multiplied together. The harmonic peak having maximum amplitude in the multiplied spectrum represents the fundamental frequency. Once the fundamental frequency of each of the one or more processed segments is detected, the control is transferred to the extractor and analyzer 410.

The extractor and analyzer module 410 is configured to calculate various audio parameters using the detected fundamental frequency for each of the one or more processed segments. The calculated audio parameters facilitate the one or more physicians in diagnosis and prescribing treatment. The audio parameters include, but not limited to, minimum fundamental frequency, maximum fundamental frequency, average fundamental frequency, the one or more jitter parameters and the one or more shimmer parameters. In an embodiment of the present invention, the extractor and analyzer module 412 comprises algorithms that calculate the one or more audio parameters using the following mathematical formulas: Average vocal fundamental frequency (f0_avg)=mean(f) Minimum vocal fundamental frequency (f0_min)=min(f) Maximum vocal fundamental frequency (f0_max)=max(f) wherein f is the fundamental frequency for each of the one or more processed segments.

In an embodiment of the present invention, the extractor and analyzer module 412 comprises algorithms that calculate the one or more jitter parameters such as, but not limited to, jitter absolute, jitter percentage, Relative Average Perturbation (RAP) and Pitch Perturbation Quotient (PPQ) which facilitate in estimating variation of pitch. In an embodiment of the present invention, the jitter absolute is the segment-to-segment variation of fundamental frequency representing the average absolute difference between consecutive segments. The jitter absolute is calculated by the one or more algorithms using the following mathematical formula:

$$Jitter\_abs = \frac{1}{n - 1} {\sum }_{i = 1}^{n - 1} {f}_{i + 1} - {f}_{i}$$

wherein n is the number of processed segments and fᵢ and fᵢ₊₁ is the fundamental frequency of two consecutive processed segments i and i+1 respectively.

In an embodiment of the present invention, the jitter percentage is defined as the ratio of jitter absolute and average of fundamental frequency extracted from all the processed segments. The jitter percentage is calculated by the one or more algorithms using the following mathematical formula:

$$Jitter \% = \frac{Jitter\_abs}{f 0 \_avg}$$

wherein f0_avg is the average fundamental frequency of all the processed segments.

In an embodiment of the present invention, the RAP is defined as the average absolute difference between the fundamental frequency of a processed segment and the average of fundamental frequency of the processed segment and two neighboring segments, divided by average of fundamental frequency extracted from all the processed segments. The RAP is calculated by the one or more algorithms using the following mathematical formula:

$$RAP = \frac{\frac{1}{n - 2} {\sum }_{2}^{n - 1} {f}_{avg over 3 segments} - {f}_{i}}{f 0 \_avg} * 100$$

wherein f_{avg over 3 segments} is average fundamental frequency of three consecutive processed segments.

In an embodiment of the present invention, the PPQ is defined as the average absolute difference between the fundamental frequency of a processed segment and the average of fundamental frequency of the processed segment and its four closest neighboring segments, divided by the average of fundamental frequency extracted from all the processed segments. The PPQ is calculated by the one or more algorithms using the following mathematical formula:

$$PPQ = \frac{\frac{1}{n - 4} {\sum }_{2}^{n - 2} {f}_{avg over 5 segments} - {f}_{i}}{f 0 \_avg} * 100$$

wherein f_{avg over 5 segments} is average fundamental frequency of five consecutive processed segments.

In an embodiment of the present invention, the extractor and analyzer module 412 comprises algorithms that calculate the one or more shimmer parameters such as, but not limited to, shimmer dB, shimmer percentage, Amplitude Relative average Perturbation (ARP) and Amplitude Perturbation Quotient (APQ) which facilitate in measuring variation of the amplitude. In an embodiment of the present invention, the shimmer db is the variability of the peak to-peak amplitude in decibels that is the average base-10 logarithm of the difference between the amplitudes of consecutive processed segments multiplied by 20. The shimmer db is calculated by the one or more algorithms using the following mathematical formula:

$$Shimmer\_dB = \frac{1}{n - 1} {\sum }_{i = 1}^{n - 1} 20 * log \frac{{A}_{i}}{{A}_{i + 1}}$$

wherein the Aᵢand Aᵢ₊₁ is the peak amplitude of two consecutive processed segments i and i+1 respectively.

In an embodiment of the present invention, the shimmer percentage is defined as the average difference between the peak amplitudes of consecutive processed segments, divided by the average peak amplitude of all the processed segments. The shimmer percentage is calculated by the one or more algorithms using the following mathematical formula:

$$Shimmer \% = \frac{\frac{1}{n - 1} {\sum }_{i = 1}^{n - 1} {A}_{i + 1} - {A}_{i}}{Amp\_avg}$$

wherein the Amp_avg is the average peak amplitude of all the processed segments.

In an embodiment of the present invention, the ARP is the average difference between a processed segment and the average of the processed segment and its two neighboring segments, divided by average of peak amplitude extracted from all the processed segments. The ARP is calculated by the one or more algorithms using the following mathematical formula:

$$ARP = \frac{\frac{1}{n - 2} {\sum }_{2}^{n - 1} {A}_{avg over 3 segments} - {A}_{i}}{Amp\_avg} * 100$$

wherein the A_{avg over 3 segments} is average peak amplitude of three consecutive processed segments.

In an embodiment of the present invention, the APQ is the average difference between the peak amplitude of a processed segment and the average of the peak amplitudes of the processed segment and its four closest neighboring segments, divided by the average peak amplitude of all the processed segments. The APQ is calculated by the one or more algorithms using the following mathematical formula:

$$APQ = \frac{\frac{1}{n - 4} {\sum }_{2}^{n - 2} {A}_{avg over 5 segments} - {A}_{i}}{Amp\_avg} * 100$$

wherein the A_{avg over 5 segments} is average peak amplitude of five consecutive processed segments.

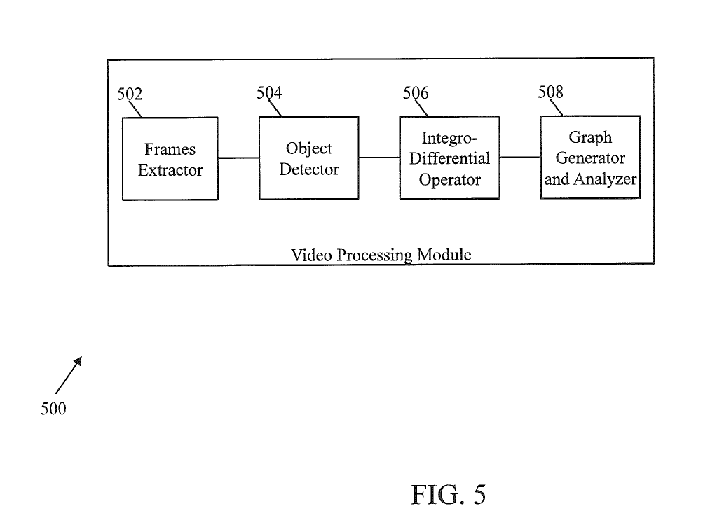

FIG. 5 is a detailed block diagram illustrating a video processing module 500, in accordance with an embodiment of the present invention. The video processing module 500 comprises a frames extractor 502, an object detector 504, an integro-differential operator 506 and a graph generator and analyzer 508.

The frames extractor 502 is configured to receive the one or more videos from the one or more patient's communication devices 102 (FIG. 1) via the patient data recording module 202 (FIG. 2). The frames extractor 502 is further configured to extract one or more frames from the one or more videos. In an embodiment of the present invention, the frames extractor extracts the one or more frames using various techniques and methods such as, but not limited to, MATLAB functions and frame extraction algorithms. The extracted one or more frames are then processed by the object detector 504 for identifying the eyes and the iris in the one or more frames.

The object detector 504 is configured to facilitate detecting the face and the eye regions in the one or more frames. In an embodiment of the present invention, the object detector 504 comprises a Viola-Jones object detection algorithm to detect the face, right eye and left eye region in the one or more frames. The Viola-Jones object detection algorithm comprises of adaptive boosting classifier. Further, the adaptive boosting classifier consists of a cascade of weak classifiers capable of detecting the face and non-face regions in the one or more frames. The adaptive boosting classifier detects Haar like features in the one or more frames. Haar-like features are digital image features used in recognizing objects such as the face and the eyes. Once the eye regions in the one or more frames are detected, the control is transferred to the integro-differential operator 506.

The integro-differential operator 506 is configured to locate an iris within the eye regions. In an embodiment of the present invention, the integro-differential operator 506 locates circles within the eye regions. Further, the integro-differential operator 506 calculates sum of pixel values within each circle which are compared with pixel value of adjacent circles. The iris is then detected as the circle with the maximum difference from its adjacent circles. The coordinates of the centroid of the iris are then calculated which are used for tracking movement of the iris.

In an embodiment of the present invention, once the eye region is detected, the integro-differential operator 506 locates the inside and outside bounds of iris using an optimization function. The optimization function searches for circular contour where there are maximum changes in pixel values by varying the radius and center coordinates position of the circular contour. Further, a pseudo-polar coordinate system is used by the integro-differential operator 506 which maps the iris within the eye and compensates for the stretching of the iris tissue as the pupil dilates. The detailed iris pattern comprising the coordinates of the centroid of the iris is then encoded into a 256-byte code by demodulating it with 2D Gabor wavelets. Furthermore, the phasor angle for each element of the iris pattern is also mapped to its respective quadrant by the integro-differential operator 506.

The graph generator and analyzer 508 is configured to generate one or more graphs illustrating the movement of the iris using the calculated coordinates of the centroid of the iris. In an exemplary embodiment of the present invention, the graphs illustrating the movement of the iris are generated based on the position of the iris in the one or more frames and the frame rate.

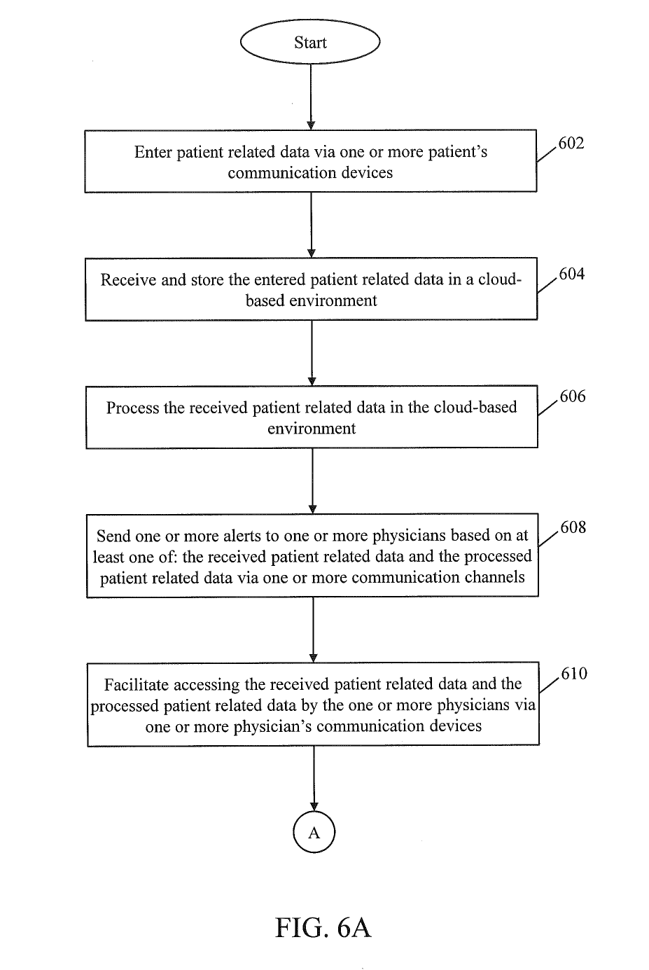

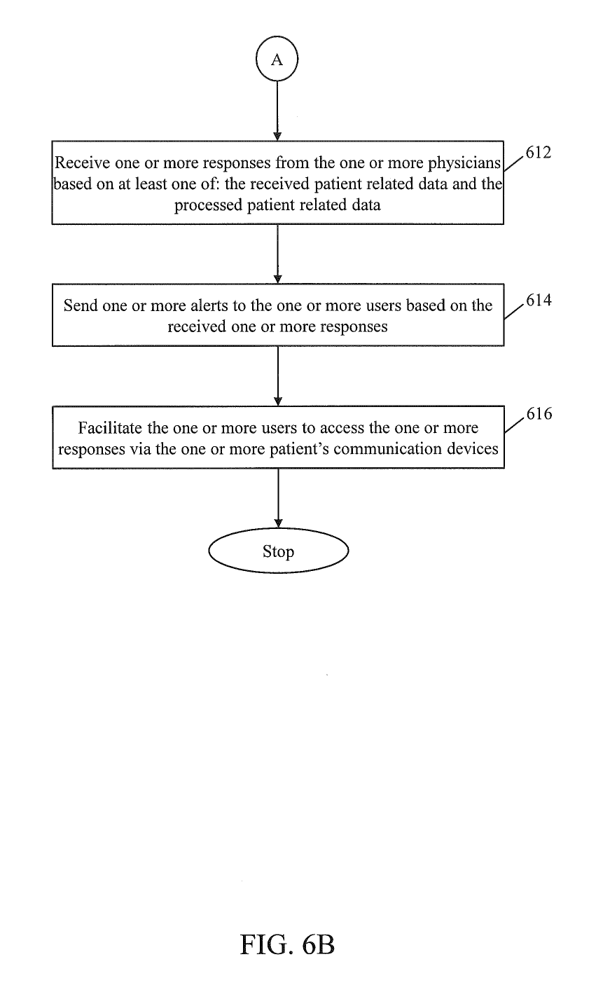

FIGS. 6A and 6B represent a flowchart illustrating a method for real-time monitoring and management of patients from a remote location, in accordance with an embodiment of the present invention.

At step 602, patient related data is entered by one or more users via one or more patient's communication devices. In an embodiment of the present invention, the patient related data includes, but not limited to, patient's personal details such as age, medical history, health complaints, symptoms and duration of symptoms, one or more patient parameters, audio/speech recordings of the one or more patients, video recordings of the one or more patients, wound images, postal address, payment details such as bank account number or credit card details. In an embodiment of the present invention, the one or more patient parameters include, but not limited to, Blood Pressure (BP) level, sugar level, temperature, pulse rate, blood cells count, ECG (Electro CardioGram) records and any other health parameters. In an embodiment of the present invention, the one or more users include, but not limited to, a patient, a Community Health Worker (CHW) and a healthcare personnel. CHWs assist one or more patients in entering the patient related data via the one or more patient's communication devices. In an embodiment of the present invention, the one or more patient's communication devices include, but not limited to, a desktop, a notebook, a laptop, a mobile phone, a smart phone and a Personal Digital Assistant (PDA). In an embodiment of the present invention, the one or more patient's communication devices comprise a healthcare application which provides an interface to the one or more users to enter the patient related data.

In an embodiment of the present invention, the one or more users enter the patient related data in a health complaint form. The health complaint form has text boxes corresponding to patient's personal details, primary health complaint, additional complaints, symptoms and their duration, insurance details, payment details, sugar level, BP level and other patient parameters and patient related data. In addition, the health complaint form has one or more options to facilitate the one or more users to upload images of ECG records, wounds, injuries and any other images and health related documents. Further, the one or more users can select appropriate options for live audio and video streaming to facilitate real-time communication between the one or more patients and one or more physicians. In an embodiment of the present invention, the one or more patients can also undergo speech tests and video tests by selecting a corresponding option provided by the healthcare application. The speech tests and the video tests are diagnostic tests which facilitate the one or more physicians in identifying diseases including, but not limited to, Progressive Supranuclear Palsy (PSP), Parkinson's, epilepsy, stroke, multiple sclerosis, Alzheimer's and other neurological disorders and diseases.

At step 604, the entered patient related data is received and stored in a cloud based environment. In an embodiment of the present invention, the cloud based environment comprises one or more repositories including, but not limited to, a patient repository to store the received data.

At step 606, the received patient related data is processed in the cloud-based environment. In an embodiment of the present invention, the cloud based environment comprises an analyzing and processing module that facilitates processing the received patient related data such as, but not limited to, the one or more images, ECG records, one or more audio recordings and one or more video to generate the processed patient related data. In an embodiment of the present invention, the processed patient related data includes, but is not limited to, one or more audio parameters calculated by processing one or more audio signals, graphs illustrating movement of the eyes and the iris generated by processing the one or more videos and data generated after analyzing and processing the patient related data such as, but not limited to, ECG records, BP level, pulse rate, blood cells count and sugar level. The processed patient related data facilitates the one or more physicians in efficiently diagnosing the health condition of the one or more patients.

At step 608, one or more alerts are sent to the one or more physicians based on at least one of: the received patient related data and the processed patient related data via one or more communication channels. In an embodiment of the present invention, the analyzing and processing module residing in the cloud based environment comprises repositories having pre-stored data corresponding to the one or more physicians. The pre-stored data corresponding to the one or more physicians include, but not limited to, physician details such as age, specialization, employment details, contact address, contact numbers and email address which is extracted and used for sending the one or more alerts to the one or more physicians. In an embodiment of the present invention, one or more Application Programming Interfaces (APIs) are invoked that facilitate sending the one or more alerts via the one or more communication channels including, but not limited to, Short Messaging Service (SMS), electronic mail and facsimile.

At step 610, the received patient related data and the processed patient related data are accessed by the one or more physicians via one or more physician's communication devices based on the one or more alerts. In an embodiment of the present invention, the one or more physician's communication devices include, but not limited to, a desktop, a notebook, a laptop, a mobile phone, a smart phone and a Personal Digital Assistant (PDA).

In an embodiment of the present invention, once the one or more physicians receive the one or more alerts, the one or more physicians access the healthcare application on the one or more physician's communication devices. The healthcare application provides an interface to the one or more physicians to access data corresponding to the one or more patients. In an embodiment of the present invention, the healthcare application in the one or more physician's communication devices comprise a search box to facilitate the one or more physicians to access the received patient related data and the processed patient related data. In an embodiment of the present invention, a physician receives a patient identification code as an alert. The physician enters the received patient identification code in the search box to access data corresponding to the patient. In an embodiment of the present invention, the one or more physicians access and analyzes the patient related data such as patient's age, symptoms and primary health complaint, the one or more patient parameters such as blood pressure and sugar levels and the processed patient related data including, but not limited to, the audio parameters and graphs illustrating the movement of the eyes and the iris for diagnosis and prescribing treatment.

At step 612, the one or more responses from the one or more physicians are received based on at least one of: the received patient related data and the processed patient related data. The one or more responses comprise information including, but not limited to, diagnosis, treatment and medical prescription. In an embodiment of the present invention the one or more responses are received by the analyzing and processing module residing in the cloud based environment via the healthcare application.

At step 614, one or more alerts are sent to the one or more users based on the received one or more responses. The one or more users are alerted of the received one or more responses via the one or more communication channels.

At step 616, the one or more users access the one or more responses via the one or more patient's communication devices. In an embodiment of the present invention, the one or more users enter a patient identification code in a search box provided by the healthcare application residing in the one or more patient's communication devices which then retrieves and renders the one or more responses on the one or more patient's communication devices.

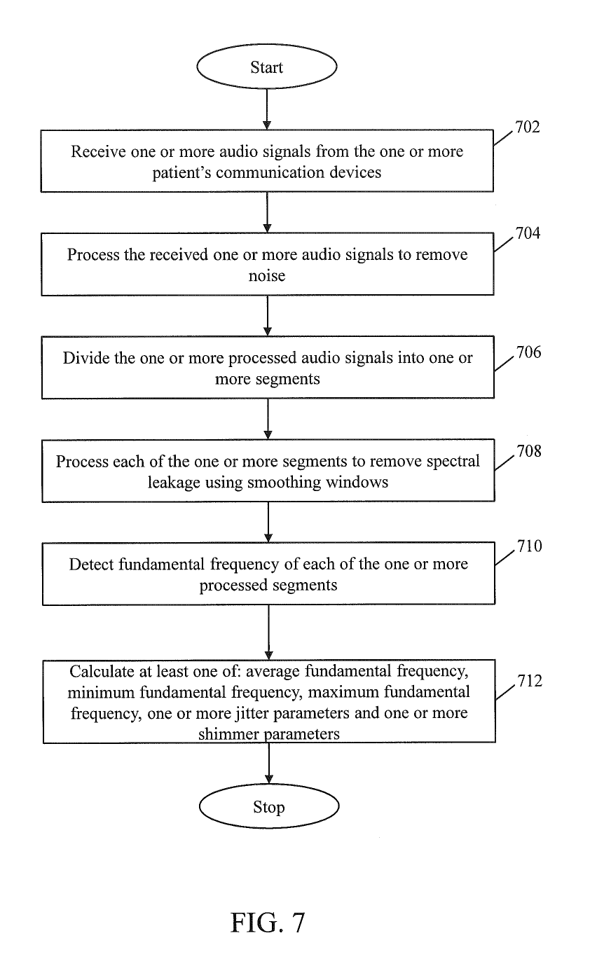

FIG. 7 is a flowchart illustrating a method for processing one or more audio signals, in accordance with an embodiment of the present invention.

At step 702, the one or more audio signals are received from the one or more patient's communication devices. The one or more audio signals are electric signals corresponding to sound/speech recordings of the one or more patients. In an embodiment of the present invention, the one or more patients undergo one or more speech tests to generate the one or more audio signals.

At step 704, the one or more received audio signals are processed to remove noise. In an embodiment of the present invention, the noise in the one or more audio signals is removed by using a notch filter. In an exemplary embodiment of the present invention, the notch filter is centered at a frequency of 50 Hz to remove the noise.

At step 706, the one or more processed audio signals are divided into one or more segments. In an embodiment of the present invention, the one or more processed audio signals are divided into one or more segments of 20 milliseconds duration with an overlap of 75% using the one or more audio segmentation algorithms.

At step 708, each of the one or more segments is processed using one or more smoothing windows to remove spectral leakage. In an embodiment of the present invention, the spectral leakage is removed by using a smoothing window such as, but not limited to, hamming window to remove edge effects that result in spectral leakage in Fast Fourier Transform (FFT) of the one or more segments. The FFT of the one or more segments facilitates in providing a graphical representation of frequency vs. amplitude of the one or more audio signals. Once each of the one or more segments are processed, the control is transferred to step 710.

At step 710, fundamental frequency of each of the one or more processed segments is detected. In an embodiment of the present invention, the fundamental frequency of each of the one or more processed segments is detected using a Harmonic Product Spectrum (HPS) algorithm. Once the fundamental frequency of each of the one or more processed segments is detected, the control is transferred to step 712.

At step 712, one or more audio parameters are calculated using the detected fundamental frequency for each of the one or more processed segments. The calculated audio parameters facilitate the one or more physicians in diagnosis and prescribing treatment. The audio parameters include, but not limited to, minimum fundamental frequency, maximum fundamental frequency, average fundamental frequency, one or more jitter parameters and one or more shimmer parameters. In an embodiment of the present invention, the one or more jitter parameters include, but not limited to, jitter absolute, jitter percentage, Relative Average Perturbation (RAP) and Pitch Perturbation Quotient (PPQ) which facilitate in estimating variation of pitch. In an embodiment of the present invention, the one or more shimmer parameters include, but not limited to, shimmer dB, shimmer percentage, Amplitude Relative average Perturbation (ARP) and Amplitude Perturbation Quotient (APQ) which facilitate in measuring variation of the amplitude.

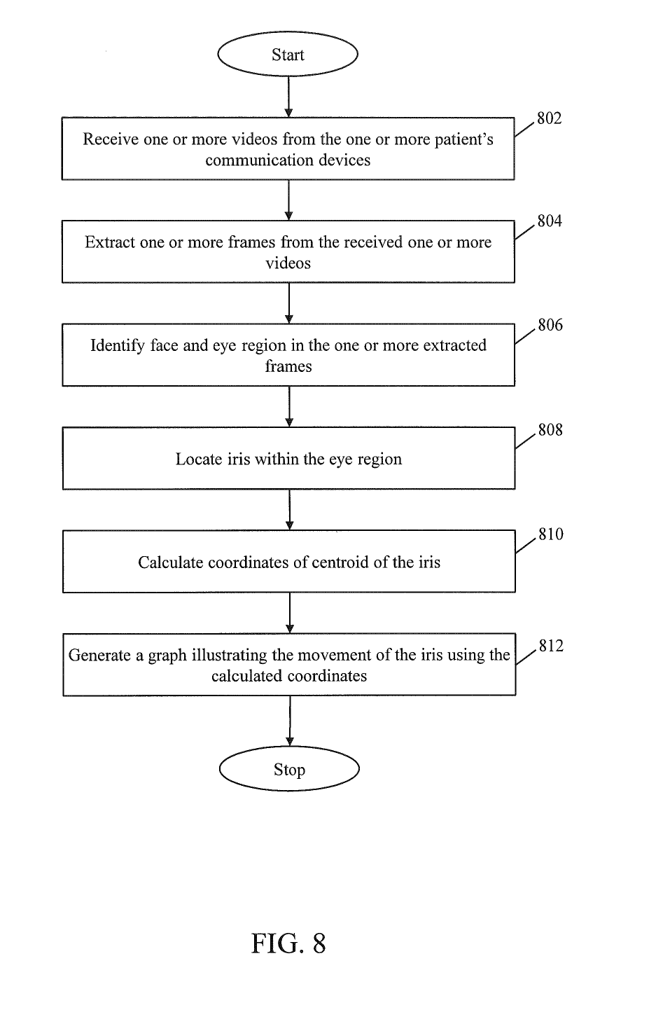

FIG. 8 is a flowchart illustrating a method for processing one or more videos, in accordance with an embodiment of the present invention.

At step 802, the one or more videos are received from the one or more patient's communication devices. In an embodiment of the present invention, the one or more patients undergo one or more video tests and record the one or more videos via the one or more patient's communication devices. In an embodiment of the present invention, the one or more videos of the one or more patients comprise recordings of movement of one or more body parts of the one or more patients.

At step 804, one or more frames from the one or more videos are extracted. In an embodiment of the present invention, the one or more videos comprise one or more frames which are extracted and processed. In an embodiment of the present invention, the one or more frames can be extracted using various techniques and methods such as, but not limited to, MATLAB functions and frame extraction algorithms.

At step 806, face and eye regions in the one or more frames are identified in the one or more extracted frames. In an embodiment of the present invention, a Viola-Jones object detection algorithm is used to detect the face, right eye region and left eye region in the one or more extracted frames. Once the eye regions in the one or more frames are detected, the control is transferred to step 808.

At step 808, iris within the eye regions is located. In an embodiment of the present invention, an integro-differential operator locates circles within the eye regions. Further, sum of pixel values within each circle are calculated and compared with pixel value of adjacent circles. The iris is then detected as the circle with the maximum difference from its adjacent circles.

At step 810, coordinates of centroid of the iris in each of the one or more frames are calculated. The coordinates of the centroid of the iris facilitate tracking movements of the iris.

At step 812, one or more graphs illustrating the movement of the iris are generated using the calculated coordinates of the centroid of the iris.

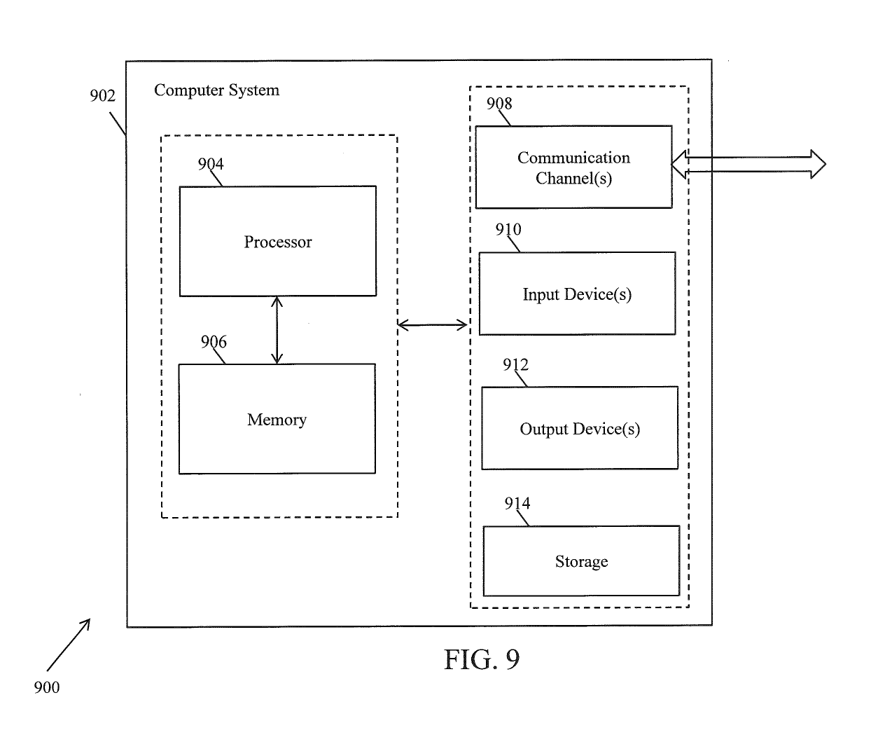

FIG. 9 illustrates an exemplary computer system in which various embodiments of the present invention may be implemented.

The computer system 902 comprises a processor 904 and a memory 906. The processor 904 executes program instructions and may be a real processor. The processor 904 may also be a virtual processor. The computer system 902 is not intended to suggest any limitation as to scope of use or functionality of described embodiments. For example, the computer system 902 may include, but not limited to, a general-purpose computer, a programmed microprocessor, a micro-controller, a peripheral integrated circuit element, and other devices or arrangements of devices that are capable of implementing the steps that constitute the method of the present invention. In an embodiment of the present invention, the memory 906 may store software for implementing various embodiments of the present invention. The computer system 902 may have additional components. For example, the computer system 902 includes one or more communication channels 908, one or more input devices 910, one or more output devices 912, and storage 914. An interconnection mechanism (not shown) such as a bus, controller, or network, interconnects the components of the computer system 902. In various embodiments of the present invention, operating system software (not shown) provides an operating environment for various softwares executing in the computer system 902, and manages different functionalities of the components of the computer system 902.

The communication channel(s) 908 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, bluetooth or other transmission media.

The input device(s) 910 may include, but not limited to, a keyboard, mouse, pen, joystick, trackball, a voice device, a scanning device, or any another device that is capable of providing input to the computer system 902. In an embodiment of the present invention, the input device(s) 910 may be a sound card or similar device that accepts audio input in analog or digital form. The output device(s) 912 may include, but not limited to, a user interface on CRT or LCD, printer, speaker, CD/DVD writer, or any other device that provides output from the computer system 902.

The storage 914 may include, but not limited to, magnetic disks, magnetic tapes, CD-ROMs, CD-RWs, DVDs, flash drives or any other medium which can be used to store information and can be accessed by the computer system 902. In various embodiments of the present invention, the storage 914 contains program instructions for implementing the described embodiments.

The present invention may suitably be embodied as a computer program product for use with the computer system 902. The method described herein is typically implemented as a computer program product, comprising a set of program instructions which is executed by the computer system 902 or any other similar device. The set of program instructions may be a series of computer readable codes stored on a tangible medium, such as a computer readable storage medium (storage 914), for example, diskette, CD-ROM, ROM, flash drives or hard disk, or transmittable to the computer system 902, via a modem or other interface device, over either a tangible medium, including but not limited to optical or analogue communications channel(s) 908. The implementation of the invention as a computer program product may be in an intangible form using wireless techniques, including but not limited to microwave, infrared, bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as an apparatus, method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

We claim:

1. A system for real-time monitoring and management of patients from a remote location, the system comprising:
one or more patient's communication devices configured to facilitate one or more users to enter patient related data via a healthcare application;
an analyzing and processing module, residing in a cloud based environment, configured to:
receive and process the patient related data;
send one or more alerts to one or more physicians based on at least one of: the received and the processed patient related data;
facilitate the one or more physicians to access the received and the processed patient related data and provide one or more responses via the healthcare application using one or more physician's communication devices; and
send one or more alerts to the one or more users and facilitate the one or more users to access the one or more responses via the healthcare application.

2. The system of claim 1, wherein the healthcare application is configured to provide an interface to the one or more users and the one or more physicians to communicate with the analyzing and processing module residing in the cloud based environment.

3. The system of claim 1, wherein the analyzing and processing module comprises a messaging module configured to send the one or more alerts to the one or more physicians and the one or more users.

4. The system of claim 1, wherein the analyzing and processing module comprises a patient data recording module configured to receive the patient related data, wherein the received patient related data includes at least one of: one or more audio signals corresponding to speech recordings of one or more patients, one or more videos of the one or more patients and values of one or more patient parameters.

5. The system of claim 4, wherein the one or more videos of the one or more patients comprise recordings of movement of one or more body parts of the one or more patients.

6. The system of claim 4, wherein the one or more patient parameters include at least one of: ECG records, Blood Pressure (BP) level, temperature, blood cells count, pulse rate and sugar level.

7. The system of claim 4, wherein the analyzing and processing module further comprises:
an audio processing module configured to process the one or more audio signals received from the patient data recording module;
a video processing module configured to process the one or more videos received from the patient data recording module;
a data analyzer configured to process and analyze the one or more patient parameters;
a patient repository configured to store at least one of: the received and the processed patient related data; and
a response module configured to facilitate the one or more physicians to access the received and the processed patient related data and further configured to facilitate updating one or more responses received from the one or more physicians in the patient repository.

8. The system of claim 7, wherein the audio processing module comprises:
a notch filter configured to process the one or more received audio signals to remove noise;
an audio segmentation module configured to divide the one or more processed audio signals into one or more segments;
a hamming window function module configured to process each of the one or more segments to remove spectral leakage using smoothing windows;
a frequency detector configured to detect fundamental frequency of each of the one or more processed segments; and
an extractor and analyzer module configured to calculate at least one of: average fundamental frequency, minimum fundamental frequency, maximum fundamental frequency, one or more jitter parameters and one or more shimmer parameters using the detected fundamental frequency of each of the one or more processed segments.

9. The system of claim 7, wherein the video processing module comprises:
a frames extractor configured to extract one or more frames from the one or more received videos;
an object detector configured to identify face and eye region in the one or more extracted frames;
an integro-differential operator configured to locate an iris within the eye region and further configured to calculate coordinates of centroid of the iris; and
a graph generator and analyzer configured to generate a graph illustrating the movement of the iris using the calculated coordinates of the centroid of the iris.

10. The system of claim 7, wherein the data analyzer processes and analyzes the one or more patient parameters by comparing the values of the one or more patient parameters with predetermined values.

11. A computer-implemented method for real-time monitoring and management of patients from a remote location, via program instructions stored in a memory and executed by a processor, the computer-implemented method comprising:
facilitating one or more users to enter patient related data via a healthcare application;
receiving and processing the patient related data;
sending one or more alerts to one or more physicians based on at least one of: the received and the processed patient related data;
facilitating the one or more physicians to access the received and the processed patient related data and provide one or more responses via the healthcare application; and
sending one or more alerts to the one or more users and facilitating the one or more users to access the one or more responses via the healthcare application.

12. The computer-implemented method of claim 11, wherein the step of receiving and processing the patient related data is performed in a cloud based environment.

13. The computer-implemented method of claim 11, wherein the step of processing the received patient related data comprises:
processing one or more audio signals corresponding to speech recordings of one or more patients to remove noise;
dividing the one or more processed audio signals into one or more segments;
processing each of the one or more segments to remove spectral leakage using smoothing windows;
detecting fundamental frequency of each of the one or more processed segments; and
calculating at least one of: average fundamental frequency, minimum fundamental frequency, maximum fundamental frequency, one or more jitter parameters and one or more shimmer parameters using the detected fundamental frequency of each of the one or more processed segments.

14. The computer-implemented method of claim 11, wherein the step of processing the patient related data comprises:
extracting one or more frames from one or more videos of one or more patients;
identifying face and eye region in the one or more extracted frames;
locating an iris within the eye region;
calculating coordinates of centroid of the iris; and
generating a graph illustrating movement of the iris using the calculated coordinates of the centroid of the iris.

15. The computer-implemented method of claim 14, wherein the one or more videos of the one or more patients comprise recordings of movement of one or more body parts of the one or more patients.

16. The computer-implemented method of claim 11, wherein the step of processing the patient related data includes comparing the values of one or more patient parameters with predetermined values.

17. The computer-implemented method of claim 16, wherein the one or more patient parameters include at least one of: ECG records, Blood Pressure (BP) level, temperature, blood cells count, pulse rate and sugar level.

18. A computer program product for real-time monitoring and management of patients from a remote location, the computer program product comprising:
a non-transitory computer-readable medium having computer-readable program code stored thereon, the computer-readable program code comprising instructions that when executed by a processor, cause the processor to:
facilitate one or more users to enter patient related data via a healthcare application;
receive and process the patient related data;
send one or more alerts to one or more physicians based on at least one of: the received and the processed patient related data;
facilitate the one or more physicians to access the received and the processed patient related data and provide one or more responses via the healthcare application; and
send one or more alerts to the one or more users and facilitate the one or more users to access the one or more responses via the healthcare application.

19. The computer program product of claim 18, wherein receiving and processing the patient related data is performed in a cloud based environment.

20. The computer program product of claim 18, wherein processing the received patient related data comprises:
processing one or more audio signals corresponding to speech recordings of one or more patients to remove noise;
dividing the one or more processed audio signals into one or more segments;
processing each of the one or more segments to remove spectral leakage using smoothing windows;
detecting fundamental frequency of each of the one or more processed segments; and
calculating at least one of: average fundamental frequency, minimum fundamental frequency, maximum fundamental frequency, one or more jitter parameters and one or more shimmer parameters using the detected fundamental frequency of each of the one or more processed segments.

21. The computer program product of claim 18, wherein processing the patient related data comprises:
extracting one or more frames from one or more videos of one or more patients;
identifying face and eye region in the one or more extracted frames;
locating an iris within the eye region;
calculating coordinates of centroid of the iris; and
generating a graph illustrating movement of the iris using the calculated coordinates of the centroid of the iris.

22. The computer program product of claim 21, wherein the one or more videos of the one or more patients comprise recordings of movement of one or more body parts of the one or more patients.

23. The computer program product of claim 18, wherein processing the patient related data includes comparing the values of one or more patient parameters with predetermined values.
